(19) United States
(12) Patent Application Publication
(10) Pub. No.: US 2009/0109692 A1
(43) Pub. Date: Apr. 30, 2009

(54) Light Fixture with Removable Lamp Housing

(75) Inventors: Paul James Bartlett, Newnan, GA (US); Timothy Shawn O'Brien, Peachtree City, GA (US); Chiu Hua Jung, Fuyong Town (CN)

Correspondence Address: KING & SPALDING, 1180 PEACHTREE STREET , NE, ATLANTA, GA, 30309-3521, US

(73) Assignee: Cooper Technologies Company, Houston, TX (US)

(21) Appl. No.: 11/928,540

(22) Filed: Oct. 30, 2007

(51) Int. Cl. F21V 19/00

(52) U.S. Cl. 362/382

(57) ABSTRACT

A lighting fixture having a socket housing and a removable lamp housing. The socket housing includes a socket for receiving a lamp and for connecting the lamp to a power supply. The lamp housing has a first end for emitting light from the lamp and a second end that is removably coupled to the socket housing. The lamp housing least partially encloses the lamp when connected to the socket housing. The second end of the lamp housing is wider than the lamp, so as to allow the lamp housing to be removed from the socket housing without first removing the lamp from the socket. Removing the lamp housing from said socket housing substantially exposes the socket to view and allows for installation of a lamp into the socket without having to re-position or re-aim the track light fixture.

### TECHNICAL FIELD

The present disclosure relates to a removable lamp housing for accessing a lamp in a track light fixture.

### BACKGROUND OF THE INVENTION

A light fixture is a device for producing, controlling, and distributing light. It is typically a complete unit consisting of one or more lamp, a socket or sockets for positioning the lamp(s) and for connecting the lamp(s) to a power supply, a covering to protect the lamp(s), optical devices for distributing the light, and mechanical components for supporting or attaching the light fixture.

“Track lighting” is a term that generally refers to a system that includes at least one such light fixture and a track or rail that is designed to support the light fixture and deliver electric power. For example, the track may be mounted at or near the ceiling surface, recessed into the ceiling, or mounted horizontally or vertically along a wall or other surface. Track lighting systems come in a variety of shapes, sizes, and configurations. Track light fixtures also come in many shapes and styles and may be designed for use with a wide variety of lamps including incandescent, halogen, metal-halide, and fluorescent. However, in the typical configuration, a track light fixture includes a housing that encloses the lamp, socket and related internal electrical and mechanical components. The housing is coupled to external mechanical components for attaching the light fixture to a track.

Optical control of track lighting system is typically accomplished by positioning the track light fixtures along the track and then aiming the positioned light fixtures at a particular target area. Often times, a light fixture will include one or more locking mechanism to lock the fixture in place once it is positioned and aimed. Other optical control techniques may rely upon reflectors, refractors, diffusers, shades, hoods, cowls, and other devices, which are either included within or mounted to the track light fixture.

Lamps in a track light fixture must typically be replaced or maintained at regular intervals, so as to keep the light fixture in working order. In most track light fixtures, however, accessing the lamps can be relatively difficult and/or time consuming. Often, a portion of the housing, such as a lens assembly, must be removed in order to access the interior of the housing. Also, unless the light fixture is moved out of its desired position, the housing itself may often obstruct the view of the socket. Thus, once the lamp replacement or maintenance is complete, the light fixture must be repositioned to direct light to the target location. This process is inefficient, particularly where a large number of lamps must be replaced or maintained.

### SUMMARY OF THE INVENTION

The present invention provides a lighting fixture having a socket housing and a lamp housing. The socket housing includes a socket for receiving a lamp and for connecting the lamp to a power supply. Depending on the type of socket included in the socket housing, the lamp may be an incandescent lamp, a halogen lamp, a metal-halide lamp, a fluorescent lamp or any other type of lamp. The lamp housing has a first end for emitting light from the lamp and a second end that is removably coupled to the socket housing. The lamp housing least partially encloses the lamp when connected to the socket housing. A lens may be mounted to the first end of the lamp housing and a reflector may be mounted within the lamp housing.

The second end of the lamp housing is preferably wider than the lamp that is intended for use within the fixture, so as to allow the lamp housing to be removed from the socket housing without first removing the lamp from the socket. Removing the lamp housing from said socket housing substantially exposes the socket to view and allows for installation of a lamp into the socket without having to re-position or re-aim the track light fixture.

In certain embodiments, the socket housing of the light fixture may include one or more locking arms and the second end of the lamp housing may include one or more tabs configured for mating with corresponding ones of said one or more locking arms, so as to removably couple the lamp housing to the socket housing. In such embodiments, each of the one or more locking arms may include a protrusion and each of the one or more tabs may include a sloped edge or a second protrusion for mating with the corresponding protrusion of the corresponding locking arm. Accordingly, the lamp housing may be coupled to the socket housing by rotating the lamp housing in a first direction relative to the socket housing to thereby mate the corresponding tabs and locking arms and may be removed from the socket housing by rotating the lamp housing in a second direction relative to the socket housing to thereby separate the corresponding tabs and locking arms.

In other embodiments, the lamp housing may be removably coupled to the socket housing by way of threads located on one of the second end of the lamp housing or the socket housing and corresponding grooves located on the other of the second end of the lamp housing or the socket housing. These and other aspects, features and embodiments of the invention will become apparent to a person of ordinary skill in the art upon consideration of the following detailed description of illustrated embodiments exemplifying the best mode for carrying out the invention as presently perceived.

### BRIEF DESCRIPTION OF THE DRAWINGS

FIG. 1 is a perspective cross-sectional view of a removable lamp housing coupled to a socket housing, in accordance with certain exemplary embodiments of the present invention.

FIG. 2 is a perspective view of a socket housing, in accordance with certain exemplary embodiments of the present invention.

FIG. 3 is a perspective view of the exemplary socket housing shown in FIG. 2, including an exploded view of a locking arm assembly thereof.

### DETAILED DESCRIPTION

The following description of exemplary embodiments of the invention refers to the attached drawings, in which like numerals indicate like elements throughout the several figures.

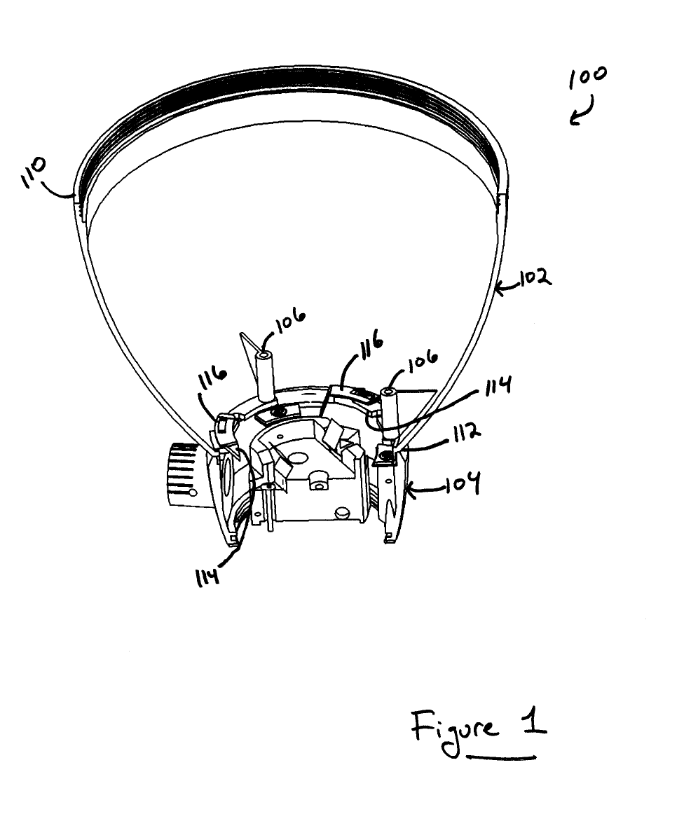

FIG. 1 is a perspective cross-sectional view of an exemplary light fixture 100, showing a removable lamp housing 102 coupled to a socket housing 104. As will be described in more detail below, the lamp housing 102 may be separated from the socket housing 104 by rotating the lamp housing 102 relative to the stationary socket housing 104. The lamp housing 102 may include mounting holes 106 for attaching a reflector, refractor, diffuser, or other component for controlling the light emitted from the lamp (not shown). A lens assembly may also be mounted within the lamp housing 102 or attached to a first end 110 of the lamp housing 102.

The lamp housing 102 includes a second end 112, which meets the socket housing 104 when the lamp housing 102 is coupled thereto. This second end 112 includes an opening that is preferably wider than the lamp (not shown) that is intended for use within the fixture, so that the lamp housing 102 may be removed from and re-coupled to the socket housing 104 without having to first remove the lamp. In certain embodiments, this second end 112 of the lamp housing 102 also includes one or more tabs 114. The tabs 114 may extend into or away from the opening in the second end 112 of the lamp housing 102.

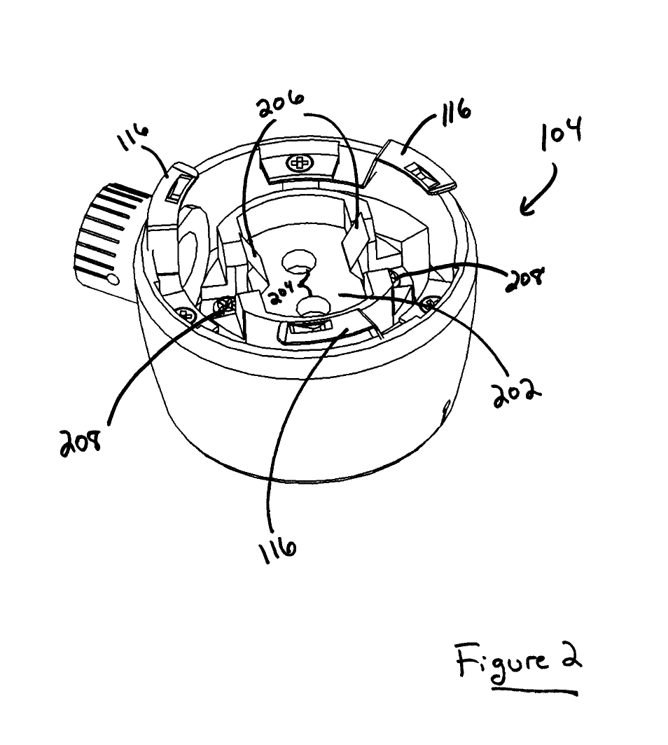

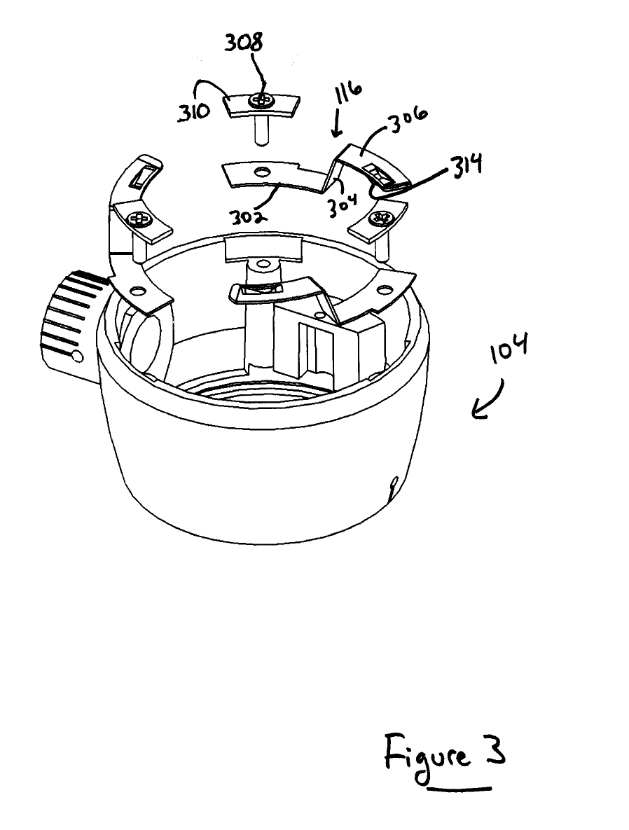

The tabs 114 are configured to mate with corresponding locking arms 116 of the socket housing 104, as will be shown and described in greater detail with respect to FIGS. 2 and 3. The tabs 114 may be formed as part of the lamp housing 102 or may be attached to the lamp housing 102. The tabs 114 and the lamp housing 102 may each be made of metal (e.g., stainless steel, aluminum, etc.), plastic, a composite or any other suitable material that is sufficiently sturdy and resistant to heat produced by the lamp. In alternative embodiments, the tabs 114 of the lamp housing 102 may be replaced by hooks, latches or other suitable quick-release connectors and the locking arms 116 of the socket housing 104 may be replaced by corresponding connectors that mate with and secure the connectors of the lamp housing 102.

FIG. 2 is a perspective view of the exemplary socket housing 104 and FIG. 3 is shows an exploded view of a locking arm 116 assembly thereof. The socket housing 104 includes a lamp socket 202 with insert holes 204 and stabilizing clamps 206 for accepting a lamp. The lamp socket 202 is coupled to the socket housing 104 with screws 208 or other connectors in a conventional manner. As previously mentioned, the socket housing 104 also includes one or more locking arms 116, configure to mate with and secure the tabs 114 of the lamp housing 102.

The locking arms 116 and the socket housing 104 may each be made of metal (e.g., stainless steel, aluminum, etc.), plastic, a composite or any other suitable material that is sufficiently sturdy and resistant to heat produced by the lamp. In certain embodiments, the lamp housing 102 includes three tabs 114 spaced along the second end 112 and the socket housing 104 includes three corresponding locking arms 116. In alternative embodiments, one or more tab 114 locking arm 116 interactions may be used to removably couple the lamp housing 102 to the socket housing 104.

In the illustrated embodiments, each locking arm 116 is formed or bent to have three sections: a lower section 302, a middle section 304 and an upper section 106. The lower section 302 and the upper section 306 lie generally parallel to the opening in the socket housing 104. The middle section 306 is angled relative to the lower section 302, so as to offset the lower section 302 and the upper section 306 in the vertical plane (i.e., above the socket housing 104, as oriented in FIGS. 2 and 3). The upper portion 306 of each locking arm 116 extends sufficiently above the socket housing 104 such that a corresponding tab 114 of the lamp housing 102 can fit thereunder, to thereby hold the lamp housing 102 securely to the socket housing 104.

The locking arms 116 may be formed as part of the socket housing 104 or may be attached to the lamp housing 104, as illustrated. For example, each locking 116 may be attached to the lamp housing 104 with a screw 308 and, optionally, a washer 310. The addition of a washer 310 adds further stability to the assembly. The screw 308 may be inserted through corresponding holes in the washer 310, the lower section 302 of the locking arm 116, and the socket housing 104. Other methods for attaching the locking arm 116 to the socket housing 104 are possible, such as the use of an adhesive or spot welding or other suitable mechanical connectors.

As should be apparent, the lamp housing 102 may be coupled to the socket housing 104 by placing the tabs 114 of the lamp housing 102 in juxtaposition with the corresponding locking arms 116 of the lamp housing 104 and rotating the lamp housing 102 until its tabs 114 slide under the corresponding locking arms 116. Conversely, the lamp housing 102 may be removed from the socket housing 104 by rotating the lamp housing 102 in the opposite direction (relative to the direction of rotation for coupling the lamp housing 102 to the socket housing 104), so as to separate the tabs 114 from the locking arms 116.

In certain embodiments, the underside of the upper portion 306 of each locking arm 116 may include a protrusion 314. The tabs 114 of the lamp housing 102 may have a ramped or sloped configuration, with the tallest edge thereof being closest to the first side 110 of the lamp housing 102 and the shortest edge thereof being closest to the second side 112 of the lamp housing 102. The tallest edge of each tab 114 may be designed to mate with or otherwise contact the protrusion 314 of the corresponding locking arm 116. In alternative embodiments, each tab 114 may be relatively flat, but include a protrusion for mating with or otherwise contacting the protrusion 314 of the corresponding locking arm 116.

In still other embodiments, each tab 114 may include a protrusion or indention for mating with or otherwise contacting a corresponding indention or protrusion on the corresponding locking arm 116. As will be readily appreciated by those of ordinary skill in the art, the corresponding protrusions, ramped edges and/or indentions of the tabs 114 and locking arms 116 will need to bypass each other when the lamp housing 102 is rotated into or out of connection with the socket housing 104, thus requiring the application of a certain amount of additional force. Accordingly, the corresponding protrusions, ramped edges and/or indentions of the tabs 114 and locking arms 116 provide for a more secure connection between the lamp housing 102 and the socket housing 104. In alternative embodiments, other means may be employed to secure the connection between the lamp housing 102 and the socket housing 104, including but not limited to a latching mechanism, a locking screw or pin, a snap, or any other suitable type of fastener or connector.

In still other embodiments, other mechanisms may be used to removably attach the lamp housing 102 to the socket housing 104. For example, the lamp housing 102 may be secured to the socket housing 104 using corresponding pins and slots, latching mechanisms, threads and grooves, etc. The ability to remove the entire lamp housing 102 from the socket housing 104 provides a clear and unobstructed view of the socket 202, which makes for easier installation of a lamp. With a clear view of the socket 202 from any angle, an installer is less likely to have to change the position or alignment of the light fixture when installing a lamp.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

We claim:

1. A lighting fixture, comprising:
a socket housing including a socket for receiving a lamp and for connecting the lamp to a power supply;
a lamp housing for at least partially enclosing the lamp, said lamp housing including a first end for emitting light from the lamp and a second end removably coupled to the socket housing; and
wherein the second end of the lamp housing is wider than the lamp so as to allow the lamp housing to be removed from the socket housing without first removing the lamp from the socket.

2. The light fixture of claim 1, wherein removing said lamp housing from said socket housing substantially exposes the socket to view.

3. The light fixture of claim 1, wherein the socket housing includes one or more locking arms; and
wherein the second end of the lamp housing includes one or more tabs configured for mating with corresponding ones of said one or more locking arms to removably couple the lamp housing to the socket housing.

4. The light fixture of claim 3, wherein each of the one or more locking arms includes a protrusion; and
wherein each of the one or more tabs includes a sloped edge for mating with the corresponding protrusion of the corresponding locking arm.

5. The light fixture of claim 3, wherein each of the one or more locking arms includes a first protrusion; and
wherein each of the one or more tabs includes a second edge for mating with the corresponding first protrusion of the corresponding locking arm.

6. The light fixture of claim 3, wherein the lamp housing is coupled to the socket housing by rotating the lamp housing in a first direction relative to the socket housing to thereby mate the corresponding tabs and locking arms; and
wherein the lamp housing is removed from the socket housing by rotating the lamp housing in a second direction relative to the socket housing to thereby separate the corresponding tabs and locking arms.

7. The light fixture of claim 1, wherein the lamp housing is removably coupled to the socket housing by way of threads located on one of the second end of the lamp housing or the socket housing and corresponding grooves located on the other of the second end of the lamp housing or the socket housing.

8. The light fixture of claim 1, further comprising a lens mounted to the first end of the lamp housing and a reflector mounted within the lamp housing.

9. The light fixture of claim 1, wherein the socket receives a lamp selected from the group consisting of: an incandescent lamp, a halogen lamp, a metal-halide lamp, and a fluorescent lamp.

10. A method of installing a lamp into a track light fixture, wherein the track light fixture comprises a socket housing including a socket for receiving a lamp and a lamp housing coupled to the socket housing for at least partially enclosing the lamp and wherein the track light fixture is positioned along a track and aimed at a target area, the method comprising:
removing the lamp housing from the socket housing without first removing the lamp from the socket, so as to substantially expose the socket to view;
installing the lamp into the socket without re-positioning or re-aiming the track light fixture; and
re-coupling the lamp housing to the socket housing.

11. The method of claim 10, wherein the socket housing includes one or more locking arms and wherein the lamp housing includes one or more tabs configured for mating with corresponding ones of said one or more locking arms; and
wherein the lamp housing is removed from the socket housing by rotating the lamp housing in a first direction relative to the socket housing to thereby separate the corresponding tabs and locking arms.

12. The method of claim 11, wherein the lamp housing is coupled to the socket housing by rotating the lamp housing in a second direction relative to the socket housing to thereby mate the corresponding tabs and locking arms.

13. The method of claim 10, wherein the lamp housing is removed from and re-coupled to the socket housing by way of threads located on one of the lamp housing or the socket housing and corresponding grooves located on the other of the lamp housing or the socket housing.

14. A lighting fixture, comprising:
a socket housing including a socket for receiving a lamp and for connecting the lamp to a power supply;
a lamp housing for at least partially enclosing the lamp, said lamp housing including a first end for emitting light from the lamp and a second end removably coupled to the socket housing;
wherein the second end of the lamp housing is wider than the lamp so as to allow the lamp housing to be removed from the socket housing without first removing the lamp from the socket; and
wherein removing said lamp housing from said socket housing substantially exposes the socket to view.

15. The light fixture of claim 14, wherein the socket housing includes one or more locking arms; and
wherein the second end of the lamp housing includes one or more tabs configured for mating with corresponding ones of said one or more locking arms to removably couple the lamp housing to the socket housing.

16. The light fixture of claim 15, wherein each of the one or more locking arms includes a protrusion; and
wherein each of the one or more tabs includes a sloped edge for mating with the corresponding protrusion of the corresponding locking arm.

17. The light fixture of claim 15, wherein each of the one or more locking arms includes a first protrusion; and
wherein each of the one or more tabs includes a second edge for mating with the corresponding first protrusion of the corresponding locking arm.

18. The light fixture of claim 15, wherein the lamp housing is coupled to the socket housing by rotating the lamp housing in a first direction relative to the socket housing to thereby mate the corresponding tabs and locking arms; and
wherein the lamp housing is removed from the socket housing by rotating the lamp housing in a second direction relative to the socket housing to thereby separate the corresponding tabs and locking arms.

19. The light fixture of claim 14, wherein the lamp housing is removably coupled to the socket housing by way of threads located on one of the second end of the lamp housing or the socket housing and corresponding grooves located on the other of the second end of the lamp housing or the socket housing.

20. The light fixture of claim 14, further comprising a lens mounted to the first end of the lamp housing and a reflector mounted within the lamp housing.

21. The light fixture of claim 14, wherein the socket receives a lamp selected from the group consisting of: an incandescent lamp, a halogen lamp, a metal-halide lamp, and a fluorescent lamp.
